(19) United States
(12) Patent Application Publication
(10) Pub. No.: US 2022/0011977 A1
(43) Pub. Date: Jan. 13, 2022

(54) STORAGE SYSTEM, CONTROL METHOD, AND RECORDING MEDIUM

(71) Applicant: Hitachi, Ltd., Tokyo (JP)

(72) Inventor: Shoichiro SUGIYAMA, Tokyo (JP)

(21) Appl. No.: 17/181,974

(22) Filed: Feb. 22, 2021

(30) Foreign Application Priority Data
Jul. 13, 2020 (JP) 2020-119663

(51) Int. Cl. G06F 3/06

(52) U.S. Cl. CPC G06F 3/0659; G06F 3/067; G06F 3/0664; G06F 3/0604

(57) ABSTRACT

To provide a storage system capable of reducing a migration amount of data upon subtraction of a storage device. Upon subtraction of a computer node 101, a distributed storage system 100 changes a computer node 101 to be a storage destination of each data element based on a static mapping table in accordance with a configuration excluding a subtracted node and on a static mapping table after replacement which represents a static mapping table prior to subtraction in which a correspondence between the computer node 101 and a virtual storage node according to a column node correspondence management table has been changed in accordance with a predetermined replacement rule.

### CROSS-REFERENCE TO PRIOR APPLICATION

This application relates to and claim the benefit of priority from

Japanese Patent Application No.2020-119663 filed on Jul. 13, 2020 the entire disclosure of which is incorporated herein by reference.

### BACKGROUND

The present disclosure relates to a computer system, a control method, and a recording medium.

WO 2017/145223 discloses a distributed storage system that uses a computer node as a storage node. In this distributed storage system, a redundant code for restoring user data is generated based on the user data and data that includes user data and a redundant code based on the user data is stored by being distributed across a plurality of computer nodes. A correspondence between each data element of the data and a computer node that stores each data element is managed by information referred to as a static mapping table.

In addition, in the distributed storage system described above, a configuration of computer nodes can be changed by adding or subtracting a computer node. The static mapping table is prepared such that redundancy of each piece of data is maintained for each configuration of the computer nodes. When changing the configuration of the computer nodes, each data element of each piece of data stored in each computer node is migrated in accordance with the static mapping table that corresponds to the configuration after the change. In WO 2017/145223, the static mapping table is set so as to minimize a migration amount which is an amount of data of data elements that migrate when adding a computer node.

### SUMMARY

With the technique described in WO 2017/145223, because there is in that the technique is configured to minimize a migration amount when adding a computer node, the migration amount increases and changing configurations takes time when subtracting a computer node.

The present disclosure has been devised in consideration of the problem described above and an object thereof is to provide a storage system, a control method, and a recording medium which are capable of reducing a migration amount of data upon subtraction of a storage node.

A storage system according to an aspect of the present disclosure is a storage system having a plurality of storage nodes configured to store in a distributed manner, for each group having a plurality of data elements including user data and a redundant code based on the user data, respective data elements of the group, the storage system including: a control unit configured to store each data element in the plurality of storage nodes based on group information including first management information that indicates a correspondence between the plurality of storage nodes and a plurality of virtual storage nodes and second management information indicating a correspondence between the data element and a virtual storage node that stores the data element, wherein the control unit is configured to change, when any of the plurality of storage nodes breaks away from the storage system, a storage node to store each data element based on group information after subtraction being the group information from which a subtracted node that is the storage node having broken away has been excluded and replacement group information which represents the group information prior to the breakaway of the subtracted node in which a correspondence between the storage node and the virtual storage node as indicated by the first management information has been changed in accordance with a predetermined replacement rule.

According to the present invention, a migration amount of data upon subtraction of a storage node can be reduced.

### BRIEF DESCRIPTION OF THE DRAWINGS

FIG. 1 is a diagram showing an example of a system configuration of a distributed storage system according to a first embodiment of the present disclosure;

FIG. 2 is a diagram showing an example of a software configuration of the distributed storage system according to the first embodiment of the present disclosure;

FIG. 3 is a diagram showing an example of configurations of a storage program and management information;

FIG. 4 is a diagram for illustrating an example of a static mapping table;

FIG. 5 is a diagram showing an example of a group mapping table;

FIG. 6 is a diagram showing an example of a column node correspondence management table;

FIG. 7 is a diagram showing an example of a node management table;

FIG. 8 is a flow chart for illustrating an example of subtraction processing;

FIG. 9 is a diagram for illustrating an example of migration processing;

FIG. 10 is a flow chart for illustrating an example of migration processing;

FIG. 11 is a diagram showing an example of a system configuration of a distributed storage system according to a second embodiment of the present disclosure;

FIG. 12 is a diagram showing an example of a column drive correspondence management table; and

FIG. 13 is a diagram for illustrating another example of a static mapping table.

### DETAILED DESCRIPTION OF THE EMBODIMENT

Hereinafter, embodiments of the present disclosure will be described with reference to the drawings.

While processing is sometimes described in the following description on the assumption that a “program” is an operating entity, since a program causes predetermined processing to be performed by appropriately using a storage resource (such as a memory) and/or a communication interface device (such as a port) by being executed by a processor (such as a CPU (Central Processing Unit)), a “processor” maybe used instead as a subject of processing. Processing described using a program as a subject may be considered processing performed by a processor or by a device including the processor (for example, a computer or a controller).

### First Embodiment

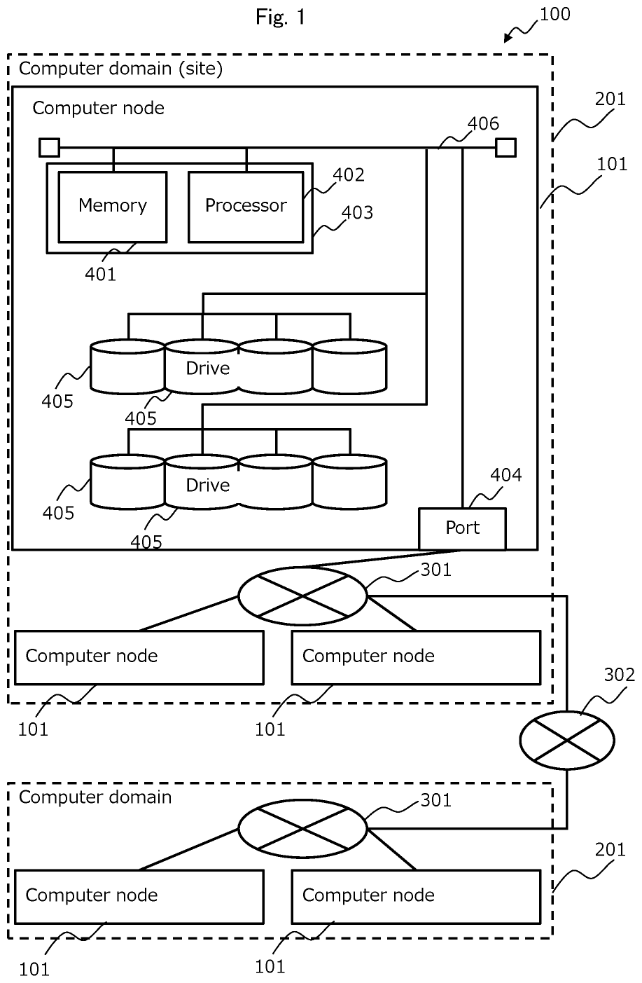

FIG. 1 is a diagram showing an example of a system configuration of a distributed storage system according to a first embodiment of the present disclosure. A distributed storage system 100 shown in FIG. 1 is a computer system having a plurality of computer nodes 101. The plurality of computer nodes 101 constitute a plurality of computer domains 201. Respective computer nodes 101 included in the same computer domain 201 are coupled to each other via a back-end network 301. Respective computer domains 201 are coupled to each other via an external network 302.

For example, the computer domain 201 maybe provided in correspondence with a geographical area or provided in correspondence with a virtual or physical topology of the back-end network 301. In the present embodiment, each domain corresponds to any of sites which are a plurality of areas being geographically separated from each other.

For example, the computer node 101 is constituted by a general server computer. In the example shown in FIG. 1, the computer node 101 has a processor package 403 including a memory 401 and a processor 402, a port 404, and a plurality of drives 405. In addition, the memory 401, the processor 402, the port 404, and the drives 405 are coupled to each other via an internal network 406.

The memory 401 is a recording medium that is readable by the processor 402 and records a program that defines operations of the processor 402. The memory 401 may be a volatile memory such as a DRAM (Dynamic Random Access Memory) or a non-volatile memory such as an SCM (Storage Class Memory).

The processor 402 is, for example, a CPU (Central Processing Unit) and realizes various functions by reading a program recorded in the memory 401 and executing the read program.

The port 404 is a back-end port which is coupled to another computer node 101 via the back-end network 301 and which transmits and receives information to and from the other computer node 101.

The drive 405 is a storage device that stores various types of data and is also referred to as a disk drive. For example, the drive 405 is a hard disk drive or an SSD (Solid State Drive) having an interface such as FC (Fibre Channel) , SAS (Serial Attached SCSI) , or SATA (Serial Advanced Technology Attachment).

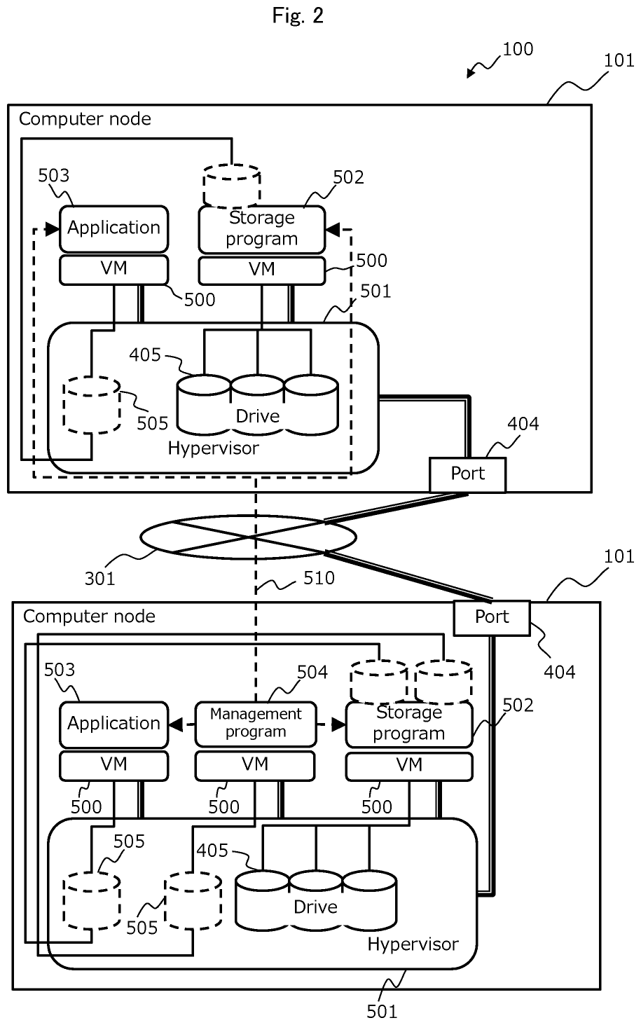

FIG. 2 is a diagram showing an example of a software configuration of the distributed storage system according to the first embodiment of the present disclosure.

The computer node 101 executes a hypervisor 501 that is software for realizing a virtual machine (VM) 500. In the present embodiment, the hypervisor 501 realizes a plurality of virtual machines 500.

The hypervisor 501 manages allocation of hardware resources with respect to each realized virtual machine 500 and actually delivers an access request with respect to a hardware resource from each virtual machine 500 to the hardware resource. Examples of the hardware resources include the memory 401, the processor 402, the port 404, the drive 405, and the back-end network 301 shown in FIG. 1.

The virtual machine 500 executes an OS (Operating System) (not illustrated) and executes various programs on the OS. In the present embodiment, the virtual machine 500 executes any of a storage program 502, an application program (abbreviated as “application” in the drawings) 503, and a management program 504. It should be noted that the management program 504 need not be executed by all computer nodes 101 and need only be executed by at least one computer node 101. The storage program 502 and the application program 503 are to be executed by all computer nodes 101.

The virtual machine 500 manages allocation of virtualized resources provided by the hypervisor 501 with respect to each executed program and delivers an access request to the hypervisor 501 with respect to a virtualized resource from each program.

The storage program 502 is a program for managing storage I/O with respect to the drive 405. The storage program 502 bundles a plurality of drives 405 and virtualizes the bundled drives 405, and provides other virtual machines 500 with the virtualized drives 405 as a virtual volume 505 via the hypervisor 501.

When the storage program 502 receives a request for storage I/O from another virtual machine 500, the storage program 502 performs storage I/O with respect to the drive 405 and returns a result thereof. In addition, the storage program 502 communicates with the storage program 502 being executed on another computer node 101 via the back-end network 301 and realizes storage functions such as data protection and data migration.

The application program 503 is a program for a user who uses the distributed storage system. When performing storage I/O, the application program 503 transmits, via the hypervisor 501, a request for storage I/O with respect to a virtual volume being provided by the storage program 502.

The management program 504 is a program for managing configurations of the virtual machine 500, the hypervisor 501, and the computer node 101. The management program 504 transmits a request for network I/O with respect to another computer node 101 via the virtual machine 500 and the hypervisor 501. In addition, the management program 504 transmits a request for a management operation with respect to another virtual machine 500 via the virtual machine 500 and the hypervisor 501. The management operation is an operation related to the configurations of the virtual machine 500, the hypervisor 501 and the computer nodes 101, and includes involves adding, subtracting, restoring computer nodes 101, and so forth.

It should be noted that the storage program 502, the application program 503, and the management program 504 may be executed on the OS that directly runs on hardware instead of on the virtual machine 500.

In the distributed storage system 100 described above, data including user data and parity data which is a redundant code having been generated based on the user data for restoring the user data is divided into a plurality of data elements in management units called chunks and stored in the plurality of computer nodes 101. Each data element may be constituted by a single piece of user data or parity data or constituted by both pieces of user data and parity data. Hereinafter, a set of user data for generating parity data may be referred to as a chunk group and a set of user data for generating parity data and the parity data may be referred to as a parity group (redundancy group).

A correspondence between each data element and the computer node 101 that is a storage node storing each data element is managed by group information that is referred to as a static mapping table.

In addition, in the distributed storage system 100, a configuration of the computer nodes 101 can be changed by adding or subtracting a computer node 101. The static mapping table is prepared such that redundancy of each data element is maintained for each configuration of the computer nodes 101 (each number of the computer nodes 101). Therefore, when changing the configuration of the computer nodes 101, the distributed storage system 100 migrates data elements stored in each computer node 101 to another computer node based on a static mapping table corresponding to a configuration after the change. In the present embodiment, the static mapping table is designed so as to minimize a migration amount which is an amount of data of data elements that migrate when adding the computer node 101.

Hereinafter, subtraction processing that is executed when subtracting a computer node 101 will be described in greater detail.

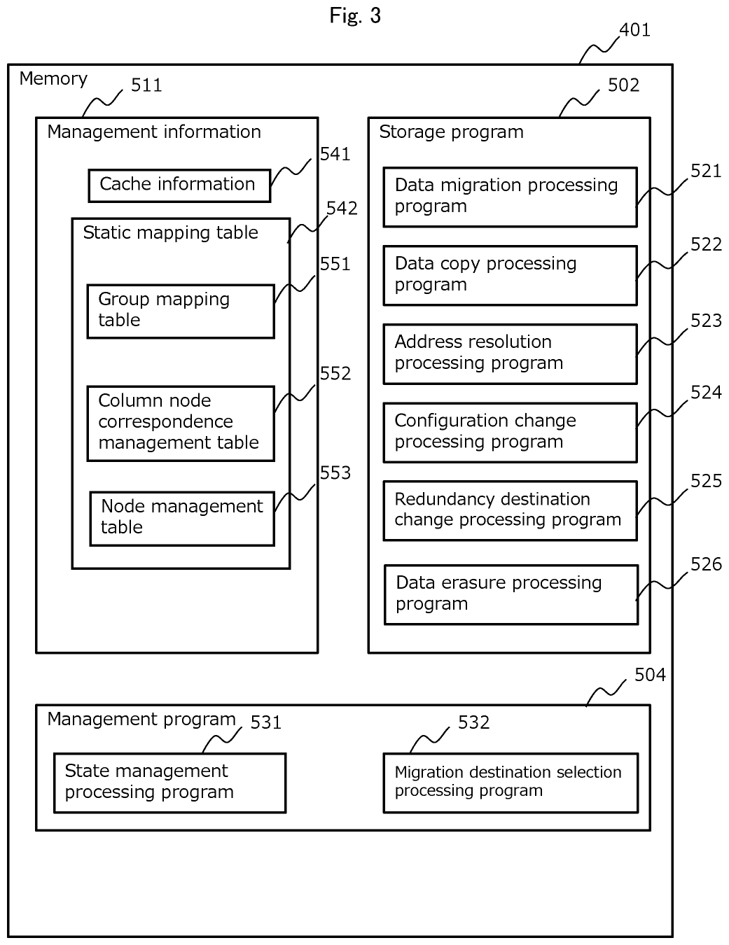

FIG. 3 is a diagram showing internal configurations of the storage program 502 and the management program 504 related to subtraction processing and an internal configuration of management information to be used in the subtraction processing.

As shown in FIG. 3, the storage program 502, the management program 504, and the management information 511 are recorded in, for example, the memory 401. The storage program 502 includes a data migration processing program 521, a data copy processing program 522, an address resolution processing program 523, a configuration change processing program 524, a redundancy destination change processing program 525, and a data erasure processing program 526. The management program 504 includes a state management processing program 531 and a migration destination selection processing program 532. The management information 511 includes cache information 541 and a static mapping table 542. The respective programs cooperate with each other to perform the subtraction processing.

The cache information 541 is information regarding data that is cached in the memory 401 by the storage program 502.

As described above, the static mapping table 542 is information indicating a correspondence between a data element and the computer node 101 that stores the data element. The static mapping table 542 includes a group mapping table 551, a column node correspondence management table 552, and a node management table 553.

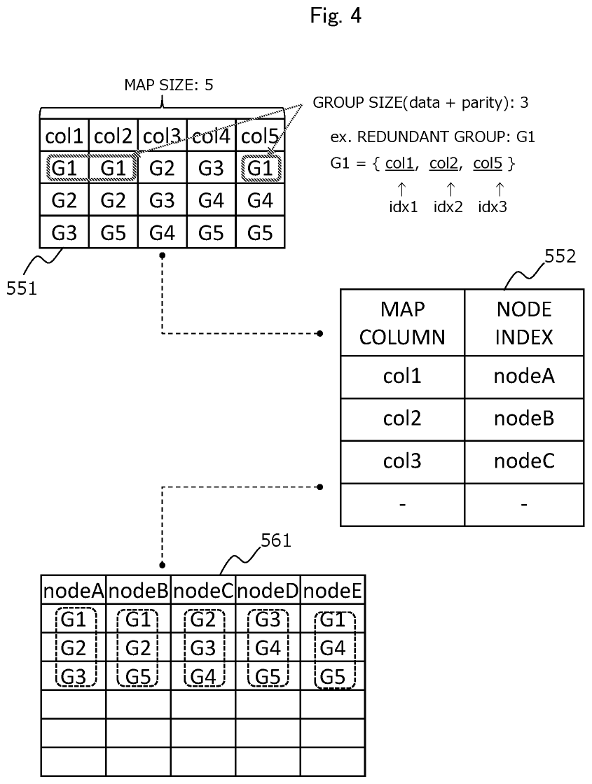

FIG. 4 is a diagram for illustrating an outline of the static mapping table 542. FIG. 4 shows the group mapping table 551 and the column node correspondence management table 552 that are included in the static mapping table 542.

The group mapping table 551 is second management information indicating a correspondence between a data element and a virtual storage node that is a virtualized storage node for storing the data element. More specifically, the group mapping table 551 indicates a column (written as “col” in the drawings) that is identification information of a virtual storage node and a parity group Gx (where x is 1 or a larger integer) of data elements to be stored in the virtual storage node. It should be noted that a column may also be referred to as a map column.

A map size that represents the number of virtual storage nodes is the same as the number of nodes that represents the number of computer nodes 101. Data elements included in a same parity group Gx are stored in different virtual storage nodes. For example, three data elements included in a parity group G1 are stored in respective virtual storage nodes of column 1, column 2, and column 5. Identification information for identifying each data element included in the parity group G1 is referred to as an index. In the example shown in FIG. 4, idxl to idx3 are shown as indices.

The column node correspondence management table 552 is first management information indicating a correspondence between a computer node 101 and a virtual storage node. More specifically, the column node correspondence management table 552 is a table having, for each computer node 101, a record having a node index that is identification information of the computer node 101 and a column indicating a virtual storage node that corresponds to the computer node.

Based on the group mapping table 551 and the column node correspondence management table 552, the distributed storage system 100 is capable of identifying, for each computer node 101, a data arrangement 561 indicating data elements that are stored in the computer node 101.

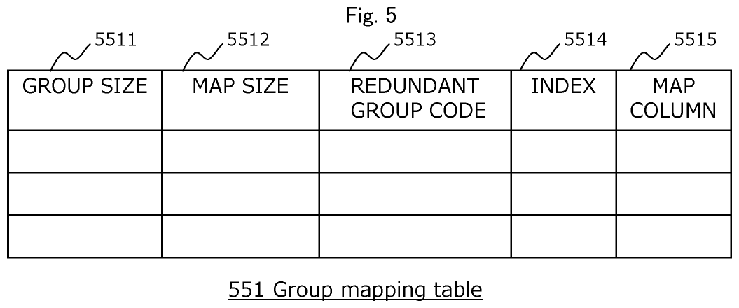

FIG. 5 is a diagram showing a more detailed example of the group mapping table 551. The group mapping table 551 includes fields 5511 to 5515.

The field 5511 stores a group size that represents the number of data elements in a parity group. The field 5512 stores a map size that represents the number of virtual storage nodes. The field 5513 stores a redundant group code that represents identification information of a parity group. The field 5514 stores an index for identifying data elements in a parity group. The field 5515 stores a map column that represents a virtual storage node in which data elements are stored.

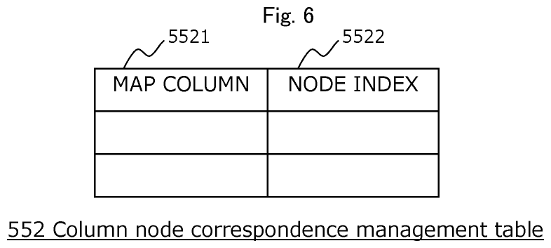

FIG. 6 is a diagram showing a more detailed example of the column node correspondence management table 552. The column node correspondence management table 552 shown in FIG. 6 includes fields 5521 and 5522. The field 5521 stores a map column. The field 5522 stores a node index that represents identification information of a computer node 101.

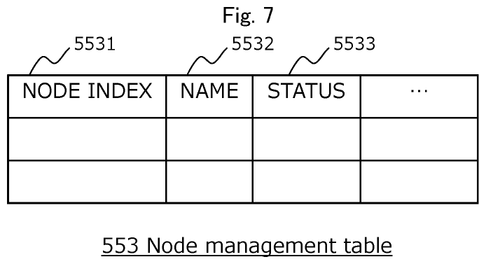

FIG. 7 is a diagram showing an example of the node management table 553. The node management table 553 shown in FIG. 7 includes fields 5531 to 5533. The field 5531 stores a node index. The field 5532 stores a name of a computer node 101. The field 5533 stores a state of the computer node 101. Examples of states of the computer nodes 101 include normal, warning, failure, being added, and being subtracted. It should be noted that the node management table 553 may be provided with other fields for storing other pieces of information.

Based on the static mapping table 542, for each parity group, the distributed storage system 100 stores, in each computer node 101, each data element included in each parity group.

In addition, when any of the computer nodes 101 breaks away (is subtracted) from the distributed storage system. 100, the distributed storage system 100 generates the static mapping table 542 in accordance with the configuration excluding a subtracted node that is the computer node 101 having broken away as the static mapping table 542 after the subtraction. The distributed storage system 100 generates the static mapping table 542 after replacement being replacement group information which represents the static mapping table 542 before subtraction in which a correspondence between the computer node 101 and the virtual storage node according to the column node correspondence management table 552 has been changed in accordance with a predetermined replacement rule. In addition, the distributed storage system 100 changes the computer node 101 to be a storage destination of each data element based on the static mapping table 542 after subtraction and the static mapping table 542 after replacement.

The replacement rule is determined in advance so as to reduce a migration amount being a data amount of data elements that migrate upon subtraction. For example, the replacement rule is determined in accordance with a generation method of the static mapping table 542 after addition in addition processing in which a new computer node 101 is added to the distributed storage system 100. In the present embodiment, in the addition processing, the distributed storage system 100 generates the static mapping table 542 after addition such that a record having a node index of an added node being the added computer node 101 and a map column of a virtual storage node corresponding to the added node is added to the end of the column node correspondence management table 552 of the static mapping table 542 before addition and that a migration amount upon addition is minimized. In this case, the replacement rule is to replace the map column of the virtual storage node that corresponds to the subtracted node with the map column of the virtual storage node included in the last record of the column node correspondence management table 552.

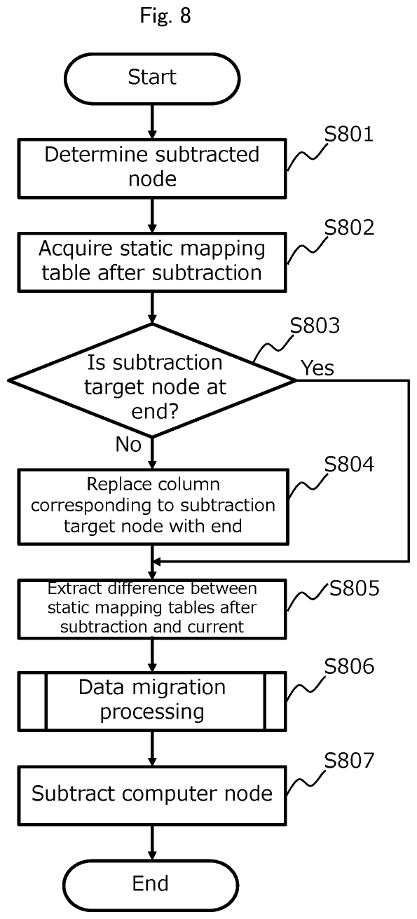

FIG. 8 is a flow chart for illustrating an example of subtraction processing.

When the management program 504 in a state management node that is one of the plurality of computer nodes 101 makes a determination to perform subtraction of a computer node 101, the management program 504 issues a subtraction request to request each computer node 101 to perform subtraction processing for subtracting the computer node. The subtraction request includes a node index of the computer node 101 to be subtracted as a subtracted index. Once the storage program 502 of each computer node 101 receives the subtraction request, the storage program 502 executes the subtraction processing.

In the subtraction processing, first, the storage program 502 acquires a subtracted index from the received subtraction request and determines the computer node 101 specified by the subtracted index as a subtracted node that is the computer node to be subtracted (step S801).

Based on the acquired subtracted index, the storage program 502 acquires the static mapping table 542 in accordance with a configuration after the subtraction (step S802).

The storage program 502 determines whether or not the subtracted index is in a last record of the column node correspondence management table 552 in the static mapping table 542 before subtraction (step S803).

When the subtracted index is not in the last record, the storage program 502 generates a static mapping table in which the map column corresponding to the subtracted index in the column node correspondence management table 552 in the static mapping table 542 before subtraction has been replaced with the map column included in the last record of the column node correspondence management table 552 before subtraction as a mapping table after replacement (step S804). When the subtracted index is in the last record, the storage program 502 skips processing of step 5804 by adopting the static mapping table 542 before subtraction as-is as the mapping table after replacement.

The storage program 502 extracts a difference between the static mapping table after replacement and the static mapping table after subtraction (step S805).

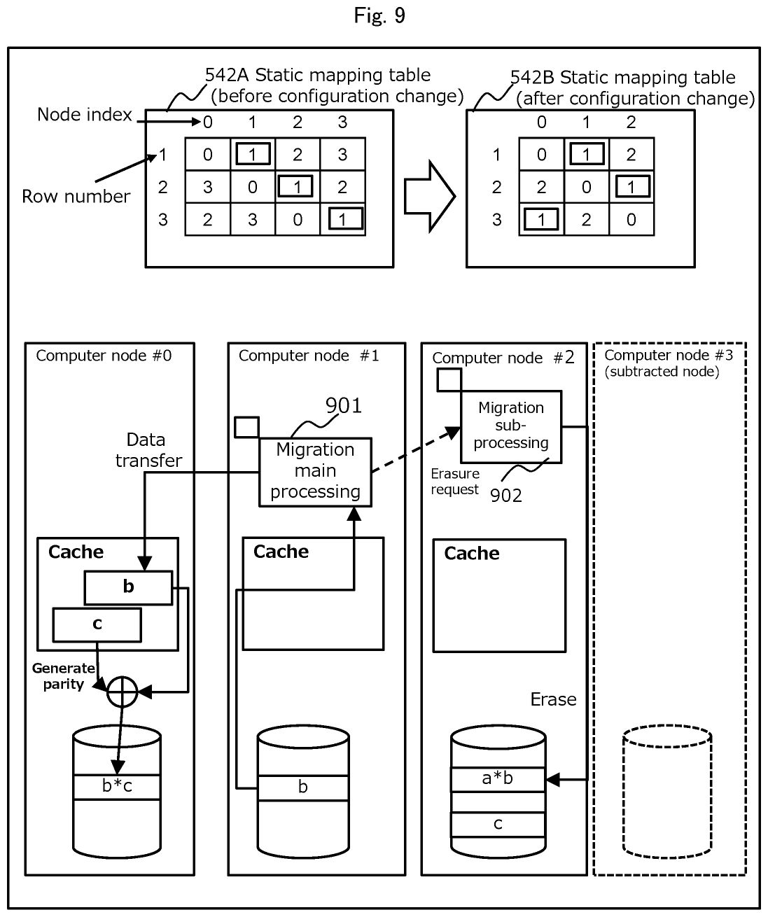

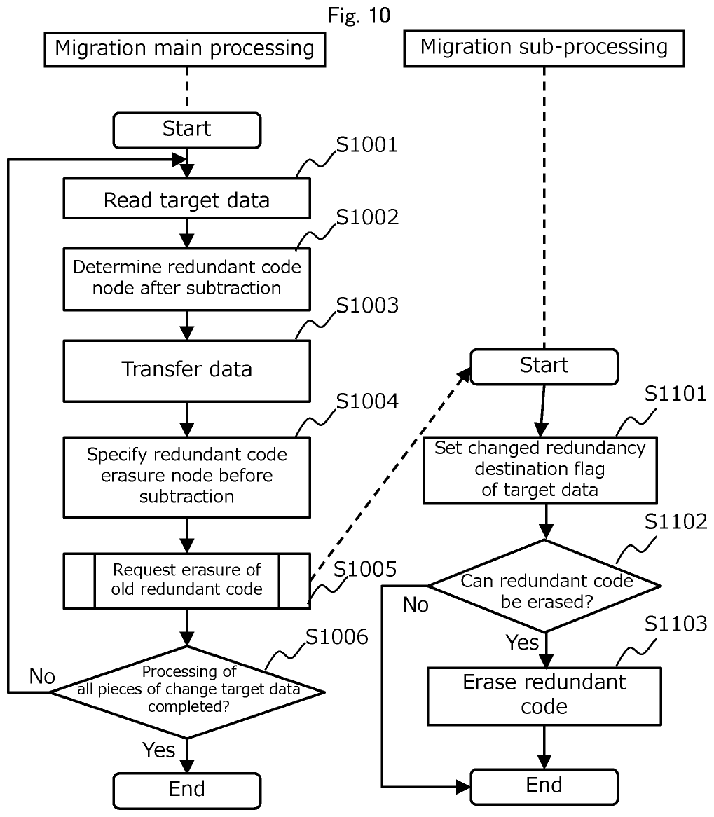

Based on the extracted difference, the storage program 502 executes migration processing (refer to FIGS. 9 and 10) in which data elements stored in the computer node 101 are migrated to another computer node (step S806) .

In addition, the storage program 502 executes subtraction of the subtracted node by discarding the static mapping table 542 before subtraction and recording the static mapping table after subtraction in the memory 401 as the static mapping table 542 (step S807), and ends the processing.

FIG. 9 is a diagram for illustrating an example of migration processing in step S806 shown in FIG. 8.

FIG. 9 shows an example where, in a distributed storage system in which four computer nodes #0 to #3 are performing data protection in a 2D+1P configuration, the computer node #3 is to be subtracted. In addition, the static mapping table 542 before subtraction is shown as a static mapping table 542A and the static mapping table 542 after subtraction is shown as a static mapping table 542B. Furthermore, FIG. 9 shows processing that involves, in the static mapping table 542A, changing data stored in the computer node #3 to be subtracted to node #0 with respect to a parity group that corresponds to data stored in row number 1 of the computer node #1.

When changing a storage position of data, first, the computer node #1 executes migration main processing 901 and reads data b that corresponds to a target parity group and refers to the static mapping table 542B after subtraction. Based on the static mapping table 542B, the computer node #1 transfers the data b to the computer node #0. The computer node #0 generates parity data b*c from the transferred data b and stores the parity data b*c in a drive.

In addition, since old parity data before subtraction of the data b is no longer required, the computer node #1 issues an erasure request to the computer node #2 storing the old parity data to erase old parity data a*b. Upon receiving the erasure request, the computer node #2 executes migration sub-processing 902 and attempts to erase the old parity data a*b in accordance with the erasure result.

By having each computer node execute the migration main processing 901 and migration sub-processing that accompanies the migration main processing 901 described above, the distributed storage system 100 can change a storage destination of parity data and perform subtraction.

A combination of data used to newly generate a parity code in the migration main processing 901 described above is determined based on the static mapping table 542B after subtraction. In the example shown in FIG. 9, the computer node #0 generates the parity data b*c using user data b that corresponds to the target parity group having been stored in the computer node #1 and user data c that corresponds to the target parity group having been stored in the computer node #2. The user data c that is used to generate the parity data b*c is transferred from the computer node #2 to the computer node #0 in the migration main processing 901 of the computer node #2.

FIG. 10 is a diagram for illustrating the migration processing in step S806 shown in FIG. 8 in greater detail.

As already described with reference to FIG. 9, the migration processing includes migration main processing and migration sub-processing. First, the migration main processing will be described.

In the migration main processing, for example, the storage program 502 searches for data that is a change target (a migration target) in each drive 405 and reads the change target data from the drive 405 (step S1001).

Based on the static mapping table after subtraction, the storage program 502 specifies a computer node to store the parity data of a target group that is a parity group of the change target data (step S1002).

The storage program 502 transfers the change target data to the specified computer node (step S1003). The storage program 502 of the computer node to become a transfer destination of the change target data generates a redundant code based on the received change target data and stores the generated redundant code in the drive 405.

Based on the static mapping table after subtraction, the storage program 502 specifies a computer node storing the parity data before subtraction of the target group (step S1004). The storage program 502 issues an erasure request of the parity data before subtraction with respect to an old redundant code node having been specified in step S1004 (S1005).

The storage program 502 determines whether or not the processing described above has been performed with respect to all pieces of change target data in all of the drives 405 (step S1006). When processing has not been performed with respect to all of the pieces of change target data, the storage program 502 returns to the processing of step S1001, but when processing has been performed with respect to all of the pieces of change target data, the storage program 502 ends the migration main processing.

Next, the migration sub-processing will be described.

In migration sub-processing, the storage program 502 of the computer node having received the erasure request determines whether or not data that is a target specified in the erasure request exists on a cache. When the target data exists on the cache, the storage program 502 erases the user data from the cache. On the other hand, when the target data does not exist on the cache, the storage program 502 configures a changed redundancy destination flag indicating that the target user data has already been made redundant by the static mapping table after subtraction (step S1101).

The storage program 502 determines whether or not parity data that corresponds to the target data can be erased (step S1102). Specifically, the storage program 502 checks the changed redundancy destination flag and determines whether or not all of the pieces of data included in a same chunk group have already been made redundant by the static mapping table after subtraction. In this case, when all of the pieces of data have already been made redundant by the static mapping table after subtraction or, in other words, when changed redundancy destination is configured to all of the pieces of data included in the same chunk group, the storage program 502 determines that parity data can be erased.

When the parity data corresponding to the target data cannot be erased, the storage program 502 ends the migration sub-processing. On the other hand, when the parity data corresponding to the target data can be erased, the storage program 502 erases the parity data (step S1103) and ends the migration sub-processing.

According to the migration processing described above, the distributed storage system 100 can generate parity data after subtraction and, at the same time, erase parity data before subtraction. Accordingly, the distributed storage system 100 can use a storage area of the parity data before subtraction as a storage area of the parity data after subtraction. In addition, since a correspondence between the computer node 101 and a virtual storage node according to the column node correspondence management table 552 can be changed so as to reduce a migration amount that is an amount of data of data elements that migrate upon subtraction, the migration amount can be reduced.

As described above, according to the present embodiment, upon subtraction of a computer node 101, the distributed storage system 100 changes a computer node 101 to be a storage destination of each data element based on the static mapping table 542 in accordance with a configuration excluding a subtracted node and on the static mapping table 542 after replacement which represents the static mapping table 542 before subtraction in which a correspondence between the computer node 101 and the virtual storage node according to the column node correspondence management table 552 has been changed in accordance with a predetermined replacement rule. Therefore, since the static mapping table 542 can be changed so as to reduce the migration amount of data elements upon subtraction of a computer node 101, the migration amount of data upon subtraction of the computer node 101 can be reduced.

In addition, in the present embodiment, the column node correspondence management table 552 is a table having, for each computer node 101, a record which associates the computer node 101 with a map column of a virtual storage node that corresponds to the computer node 101. When a computer node 101 is subtracted, the distributed storage system 100 changes a correspondence between the computer node 101 and a virtual storage node by replacing a map column of a virtual computer node that corresponds to the subtracted node with a map column of a predetermined virtual computer node in the column node correspondence management table 552. Therefore, since a correspondence can be readily changed, a migration amount of data upon subtraction of the computer node 101 can be readily reduced.

In addition, in the present embodiment, when a computer node 101 is added, the distributed storage system 100 generates the static mapping table 542 after addition by adding a record that associates a node index of an added node with a map column of a virtual storage node corresponding to the added node to the end of the column node correspondence management table 552 before subtraction. Furthermore, when a computer node 101 is subtracted, the distributed storage system 100 replaces the map column of the virtual storage node that corresponds to the subtracted node with the map column of the virtual storage node included in the last record of the column node correspondence management table 552. Therefore, by determining a migration amount of data upon addition of a computer node 101 so as to minimize the migration amount, the migration amount of data can also be reduced upon subtraction of the computer node 101.

Furthermore, in the present embodiment, the distributed storage system 100 changes a storage node to store each data element based on a difference between the group mapping table 551 after subtraction and the group mapping table 551 before subtraction and after replacement. In this case, a migration amount of data can be reduced.

In addition, in the present embodiment, the distributed storage system 100 is a computer system including a plurality of computer nodes each having the drive 405 that is a storage device and the processor 402. A control unit to perform subtraction processing is constituted by the processor of each computer.

### Second Embodiment

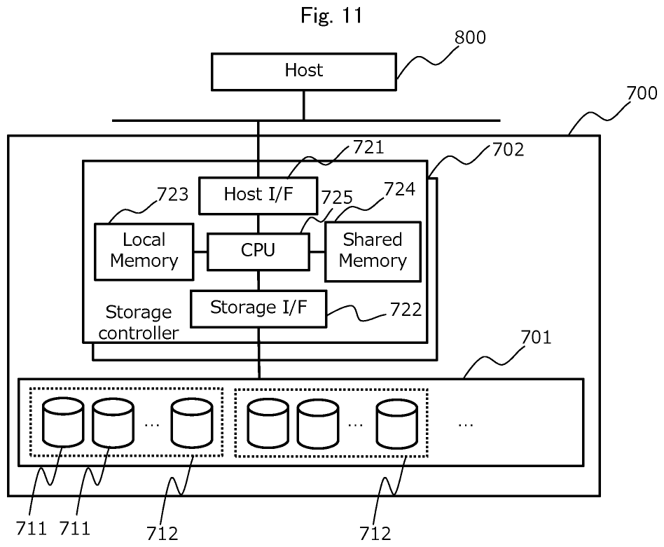

FIG. 11 is a diagram showing an example of a system configuration of a distributed storage system according to a second embodiment of the present disclosure. A distributed storage system 700 shown in FIG. 11 is a storage apparatus that stores data in a plurality of drives in a distributed manner in accordance with a request from a host 800 that is a higher-level apparatus. The distributed storage system 700 stores data in a distributed manner using, for example, a RAID (Redundant Array of Independent (or Inexpensive) Disks) system.

The distributed storage system 700 has a storage unit 701 and a storage controller 702.

The storage unit 701 includes a drive 711 that is a storage device in plurality. The plurality of drives 711 may be divided into one or a plurality of virtual groups 712 (for example, RAID groups) which constitute a single virtual drive.

The storage controller 702 is a control unit that controls write and read of data to and from the drive 711. While the storage controller 702 in the illustrated example has been duplexed in order to improve reliability by creating a replica of data to be read and written, the storage controller 702 may not be duplexed or may be multiplexed three times or more.

The storage controller 702 has a host I/F (Interface) 721, a storage I/F 722, a local memory 723, a shared memory 724, and a CPU (Central Processing Unit) 725.

The host I/F 721 communicates with the host 800. The storage I/F 722 communicates with the drive 711. The local memory 723 and the shared memory 724 are used for temporary storage of data to be written into and read from the drive 711, storage of a program that defines operations of the CPU 725 and management information to be used by the CPU 725, and the like. The CPU 725 is a computer that realizes various functions by reading a program recorded in the local memory 723 and the shared memory 724 and executing the read program.

Even in the distributed storage system 700 according to the present embodiment, a correspondence between each data element of a parity group and the drive 711 that is a storage node storing each data element is managed by a static mapping table. For example, the static mapping table is stored in the local memory 723 or the shared memory 724.

The static mapping table according to the present embodiment differs from the static mapping table 542 according to the first embodiment in that the static mapping table has a column drive correspondence management table in place of a column node correspondence management table as first management information.

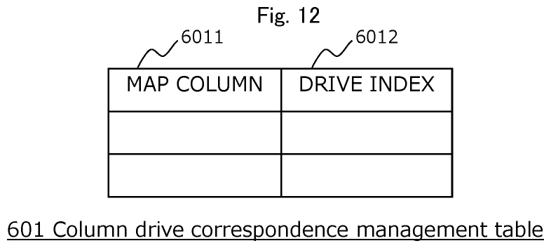

FIG. 12 is a diagram showing an example of a column drive correspondence management table. A column drive correspondence management table 601 shown in FIG. 12 includes fields 6011 and 6012. The field 6011 stores a column (a map column) that represents dentification information of a virtual storage node. The field 6012 stores a drive index that represents identification information of the drive 711.

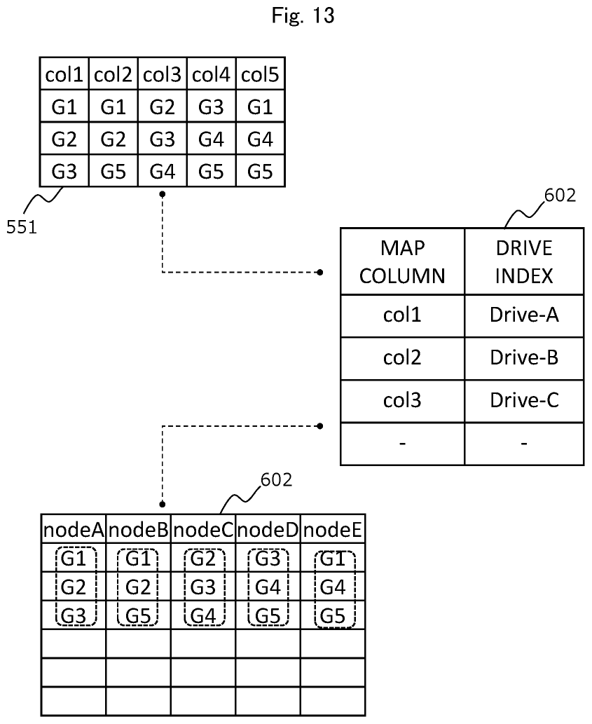

FIG. 13 is a diagram for illustrating an outline of a static mapping table according to the present embodiment. FIG. 13 shows the group mapping table 551 and the column drive correspondence management table 601 that are included in the static mapping table.

As shown in FIG. 13, based on the group mapping table 551 and the column drive correspondence management table 602, the storage controller 702 (the CPU 725) is capable of identifying, for each drive 711, a data arrangement 603 indicating data elements that are stored in the drive 711.

In addition, even in the distributed storage system 700, a configuration of the drives 711 can be changed by adding or subtracting a drive 711. The static mapping table is prepared such that redundancy of each data element is maintained for each configuration of the drives 711. Therefore, when changing the configuration of the drives 711, the distributed storage system 700 migrates data elements stored in each drive 711 to another computer node based on a static mapping table corresponding to a configuration after the change. In the present embodiment, the static mapping table is designed so as to minimize a migration amount which is an amount of data of data elements that migrate when adding a drive in a similar manner to the first embodiment.

When any of the drives 711 breaks away (is subtracted) from the distributed storage system 700, the storage controller 702 (the CPU 725) generates a static mapping table in accordance with a configuration that excludes a subtracted node that is the drive 711 having broken away as a static mapping table after subtraction. The storage controller 702 generates a static mapping table after replacement being replacement group information which represents the static mapping table before subtraction in which a correspondence between the drive 711 and the virtual storage node according to the column drive correspondence management table 601 has been changed in accordance with a predetermined replacement rule. In addition, the storage controller 702 changes the drive 711 to be a storage destination of each data element based on the static mapping table after subtraction and the static mapping table after replacement. The replacement rule is determined in advance so as to reduce a migration amount being a data amount of data elements that migrate upon subtraction in a similar manner to the first embodiment.

As described above, even in the present embodiment, since the static mapping table can be changed so as to reduce the migration amount of data elements upon subtraction of a drive 711, the migration amount of data upon subtraction of the drive 711 can be reduced.

The respective embodiments of the present disclosure described above merely represent examples for illustrating the present disclosure, and it is to be understood that the scope of the present disclosure is not to be solely limited to the embodiments. It will be obvious to those skilled in the art that the present disclosure can be implemented in various other modes without departing from the scope of the present disclosure.

What is claimed is:

1. A storage system having a plurality of storage nodes configured to store in a distributed manner, for each group having a plurality of data elements including user data and a redundant code based on the user data, respective data elements of the group, the storage system comprising:
a control unit configured to store each data element in the plurality of storage nodes based on group information including first management information that indicates a correspondence between the plurality of storage nodes and a plurality of virtual storage nodes and second management information indicating a correspondence between the data element and a virtual storage node that stores the data element, wherein
the control unit is configured to change, when any of the plurality of storage nodes breaks away from the storage system, a storage node configured to become a storage destination of each data element based on group information after subtraction being the group information from which a subtracted node that is the storage node having broken away has been excluded and replacement group information which represents the group information prior to the breakaway of the subtracted node in which a correspondence between the storage node and the virtual storage node as indicated by the first management information has been changed in accordance with a predetermined replacement rule.

2. The storage system according to claim 1, wherein the first management information is a table having, for each storage node, a record that associates identification information of the storage node with identification information of the virtual storage node corresponding to the storage node, and
the control unit is configured to change the correspondence in the table when any of the plurality of storage nodes breaks away from the storage system by replacing the identification information of the virtual storage node that corresponds to the subtracted node with identification information of a predetermined virtual storage node.

3. The storage system according to claim 2, wherein the control unit is configured to generate, when a storage node is newly added to the storage system, the group information in which a record associating identification information of an added node that is the added storage node with identification information of a virtual storage node that corresponds to the added node has been added to an end of the table, and when any of the plurality of storage nodes breaks away from the storage system, replace the identification information of the virtual storage node that corresponds to the subtracted node with identification information of the virtual storage node that is included in the last record of the table.

4. The storage system according to claim 1, wherein the control unit is configured to change a storage node configured to store each data element based on a difference between second management information of the group information after subtraction and second management information of the replacement group information.

5. The storage system according to claim 1, wherein
the storage system is a computer system including a plurality of computer nodes having a storage device configured to store the data element and a processor,
storage node is the computer node, and
control unit is constituted by the processor of each computer.

6. The storage system according to claim 1, wherein the storage system comprises a plurality of storage devices configured to store the data element and a storage controller configured to control read and write of data with respect to each storage device,
the storage node is the storage device, and
the control unit is the storage controller.

7. A control method of a storage system having a plurality of storage nodes that store in a distributed manner, for each group having a plurality of data elements including user data and a redundant code based on the user data, respective data elements of the group, the control method comprising:
storing each data element into the plurality of storage nodes based on group information including first management information that indicates a correspondence between the plurality of storage nodes and a plurality of virtual storage nodes and second management information indicating a correspondence between the data element and a virtual storage node that stores the data element; and
changing, when any of the plurality of storage nodes breaks away from the storage system, a storage node to store each data element based on group information after subtraction being the group information from which a subtracted node that is the storage node having broken away has been excluded and replacement group information which represents the group information prior to the breakaway of the subtracted node in which a correspondence between the storage node and the virtual storage node as indicated by the first management information has been changed in accordance with a predetermined replacement rule.

8. A non-transitory and tangible recording medium having recorded therein a program to be executed by a storage system having a plurality of storage nodes that store in a distributed manner, for each group having a plurality of data elements including user data and a redundant code based on the user data, respective data elements of the group, the recording medium having recorded therein a program that causes the storage system to execute the steps of:
storing each data element into the plurality of storage nodes based on group information including first management information that indicates a correspondence between the plurality of storage nodes and a plurality of virtual storage nodes and second management information indicating a correspondence between the data element and a virtual storage node that stores the data element; and
changing, when any of the plurality of storage nodes breaks away from the storage system, a storage node to store each data element based on group information after subtraction being the group information from which a subtracted node that is the storage node having broken away has been excluded and replacement group information which represents the group information prior to the breakaway of the subtracted node in which a correspondence between the storage node and the virtual storage node as indicated by the first management information has been changed in accordance with a predetermined replacement rule.
